(19) United States
(12) Patent Application Publication
(10) Pub. No.: US 2011/0126087 A1
(43) Pub. Date: May 26, 2011

(54) GRAPHICAL USER INTERFACE FOR NON MOUSE-BASED ACTIVATION OF LINKS

(76) Inventor: Andreas Matthias Aust, Hannover (DE)

(21) Appl. No.: 12/737,179

(22) PCT Filed: Jun. 27, 2008
(86) PCT No.: PCT/IB2008/001713

§ 371 Date: Feb. 2, 2011

(51) Int. Cl. G06F 17/00

(52) U.S. Cl. 715/206

(57) ABSTRACT

A method for browsing electronic media with hyperlinks is provided. A media document including a plurality of hyperlinks organized into sub-regions is provided. At least one first control element is provided configured to at least activate each individual sub-region. A second control element can be provided configured to activate each individual hyperlink in an activated sub-region.

### TECHNICAL FIELD

The present principles generally relate to electronic media browsing, and more particularly, to a system and method for providing browsing capabilities for electronic media including hyperlinked content.

### DESCRIPTION OF RELATED ART

Many forms of electronic media today, e.g., websites, include HTML (Hypertext Markup Language) content which can comprise numerous hyperlinks. Hyperlinks are reference or navigation elements in a document to another section of the same document, a different document, a specified section of another document, etc., that automatically brings the referred information to the user when the navigation element is selected (‘clicked on’) by the user.

When browsing the Internet using a device such as a PC or a mobile phone with a keyboard or dedicated buttons, hyperlinks can be selected by using the TAB′ key on a keyboard and pressing the ‘Return’ key. This technique is sometimes preferable to using a pointer device (‘mouse’) to select a hyperlink.

However, in situations where web pages contain numerous hyperlinks and it is not feasible to use a pointing device, the process of arriving at and selecting a desired link can be tedious. That is, when considering a web page with 50 links, it is inconvenient and time-consuming to reach the 40^{th} link by scrolling through all the previous 39 links individually.

Additionally, an alternative approach for navigating through web pages, especially for portable devices, involves the use of a touch screen interface. For example, the touch activated interface used with the IPhone™ produced by Apple Computer. Such a phone allows a user to select a hyperlink by touching such a hyperlink on the screen of the phone. The problem with such an interface however is that a user first has to manually zoom in or out of the screen enough so that only one hyperlink can be touched. Many times however, the hyperlinks are so close together on a web page that a user touches two different hyperlinks at the same time. Hence, a user must manually expand a webpage so that an individual hyperlink can be selected to prevent this problem.

### SUMMARY

A method, apparatus and system in accordance with various embodiments of the present principles address the deficiencies of the prior art by providing a system and method for improved media browsing, namely, of electronic media documents containing hyperlinks.

In one aspect, a system for browsing electronic media is provided including a media document including a plurality of hyperlinks organized into sub-regions. At least one first control element is provided configured to at least activate each individual sub-region.

In another aspect, a method for browsing a media document having hyperlinks is provided including the steps of activating at least one sub-region on the media document, activating at least one hyperlink in the activated sub-region, and selecting the activated link in the activated sub-region.

In yet another aspect, a method for browsing electronic media is provided including the steps of organizing a media document including a plurality of hyperlinks into a plurality of sub-regions, and providing at least one first control element configured to at least activate each individual sub-region.

These and other aspects, features and advantages of the present principles will be described or become apparent from the following detailed description of the preferred embodiments, which is to be read in connection with the accompanying drawings.

### BRIEF DESCRIPTION OF THE DRAWINGS

In the drawings, wherein like reference numerals denote similar elements throughout the views:

FIG. 1 is an exemplary media document comprising a web page including a plurality of hyperlinks for illustrative purposes;

FIG. 2A is an exemplary media document comprising a web page including a plurality of hyperlinks organized into sub-regions according to one embodiment of the present principles;

FIG. 2B is an exemplary media document comprising a first sub-region of a web page including a plurality of hyperlinks according to one embodiment of the present principles;

FIG. 2C is an exemplary media document comprising a second sub-region of a web page including a plurality of hyperlinks according to one embodiment of the present principles;

FIG. 3A is an exemplary media document comprising a web page including a plurality of hyperlinks, wherein groups of hyperlinks are organized according to another embodiment of the present principles;

FIG. 3B is an exemplary media document comprising a web page including a plurality of hyperlinks, wherein groups of hyperlinks are organized according to another embodiment of the present principles;

FIG. 4 is an exemplary method flow for providing a system for browsing electronic media according to an aspect of the present principles; and

FIG. 5 is an exemplary method flow for browsing electronic media according to an aspect of the present principles.

FIG. 6 is an exemplary method flow for determining how to distribute hyperlinks within sub-regions, according to an aspect of the present principles.

It should be understood that the drawings are for purposes of illustrating the concepts of the present principles and are not necessarily the only possible configuration for illustrating the present principles.

### DETAILED DESCRIPTION OF PREFERRED EMBODIMENTS

It should be understood that the elements shown in the FIGS. can be implemented in various forms of hardware, software or combinations thereof. Preferably, these elements are implemented in a combination of hardware and software on one or more appropriately programmed general-purpose devices, which can include a processor, memory and input/output interfaces.

It will be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative system components and/or circuitry embodying the present principles. Similarly, it will be appreciated that any flow charts, flow diagrams, state transition diagrams, pseudocode, and the like represent various processes which can be substantially represented in computer readable media and so executed by a computer or processor, whether or not such computer or processor is explicitly shown.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read only memory (“ROM”) for storing software, random access memory (“RAM”), and nonvolatile storage.

Other hardware, conventional and/or custom, can also be included. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function.

Advantageously, according to one aspect of the present principles, a system and method for browsing media with hyperlink content with improved efficiency and convenience is heretofore provided. The system and method according to the present principles can advantageously be incorporated and utilized in PCs as well as handheld devices, such as mobile phones, personal desk assistants, and other types of devices that have web browsing capability. While hyperlinks are widely utilized in the World Wide Web in web pages or in program languages such as ActiveX or JAVA which are used to render web pages, a system and method according to the present principles is not limited to HTML or the web, and can be applied to any application (e.g., media document) in which a user needs to make a selection from a large number of available (i.e., visible) objects. These objects are usually represented by selectable elements (e.g., rectangles with thumbnails of video sequences or audio waveforms). For example, hyperlinks and any other types of selectable elements can be incorporated in almost any application processing electronic media, such as video recordings, audio recordings, multimedia presentations, slide presentations, CD-ROM as well as online content. Thus, a system and method according to the present principles can be incorporated in, e.g., a video or audio editing tool where scenes or audio snippets displayed in tracks on a timeline can be selected for further processing, or speadsheet software where cells need to be selected for entering values. Further, a system and method for browsing electronic media according to the present principles can be utilized in any equipment used in the electronic communication process (e.g. television, radio, telephone, desktop computer, game console, handheld device, etc.). Note that electronic media can be in either analog or digital format.

For purposes of the invention, the term “link” or “hyperlink” will represent a selectable element which is in an electronic document which, when selected, will bring up a second electronic document (web page, audio, video, and the like) which corresponds to the selectable element.

Also for purposes of the invention, the term “control element” is used which is defined as an input element such a button, key, dial, mouse, or other type of element which is used as a means for selecting or inputting a command.

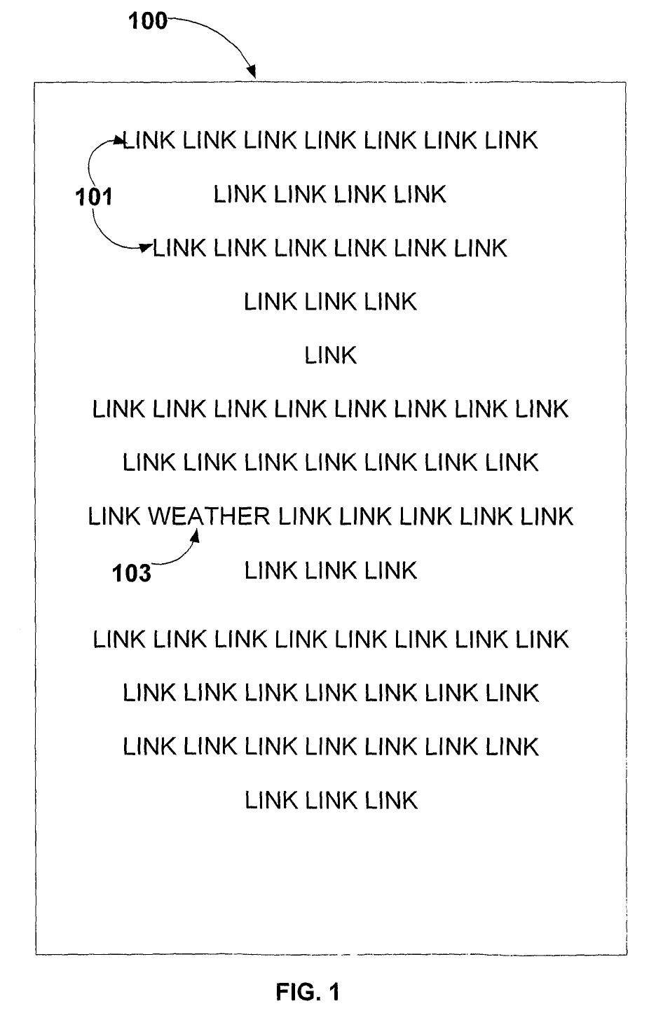

Referring now to the Figures, an exemplary electronic media application in the form of a typical web page 100 is shown including a plurality of hyperlinks 101 in FIG. 1. As can be seen, numerous hyperlinks 101 can be provided at various locations on a given web page. If a user desires to select a particular link using a keyboard (e.g., on a PC or handheld device), depending on the hyperlink's location on the webpage, such selection process can be tedious. For example, if a user desires to select the ‘Weather’ hyperlink 103 using the keyboard, the user would have to deploy the keyboard ‘Tab’ button about thirty-seven times, scrolling through previously-listed links individually in consecutive order (e.g., typically from top to bottom) in order to arrive at the desired link.

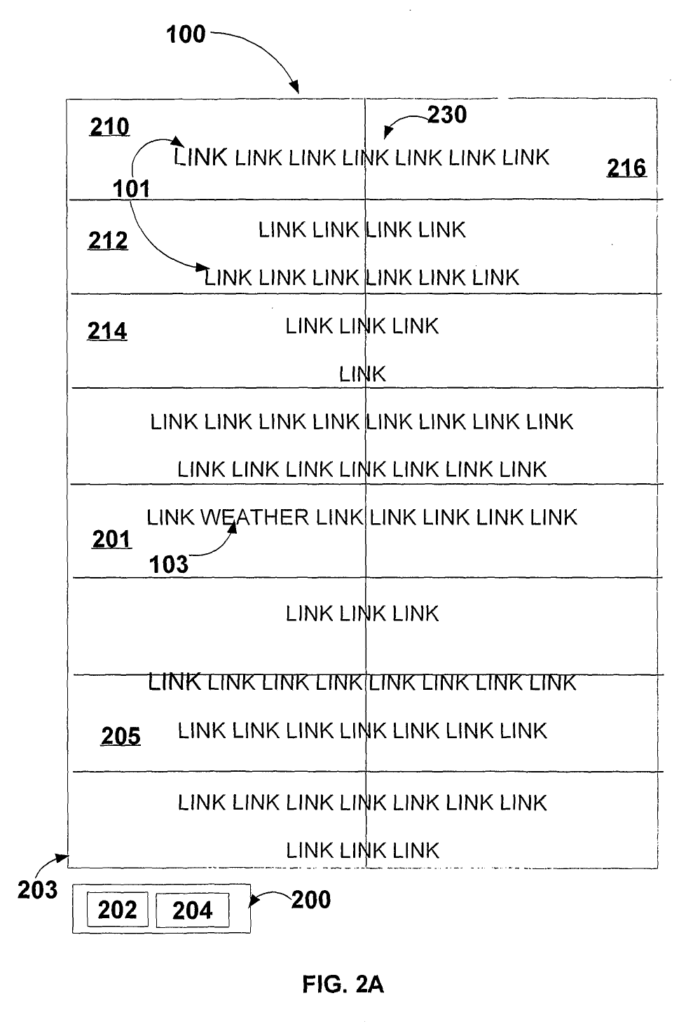

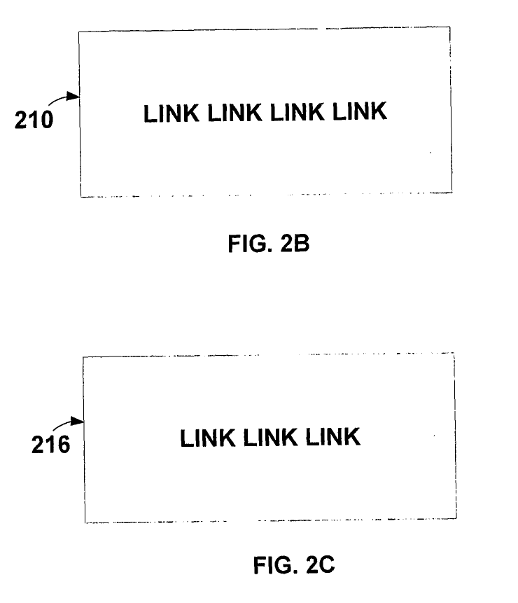

FIG. 2A is an exemplary media browsing system including a media document or application in the form of an exemplary webpage 100 having plurality of hyperlinks 101 organized into sub-regions 201 and a control apparatus 200 according to one embodiment of the present principles. According to one aspect, focus regions 201 can be created by providing superimposing grid 203 onto the webpage 100, preferably covering all areas of the webpage 100 that include hyperlinks. The grid 203 can include a plurality of sub-regions or focus regions 201, which can be evenly distributed throughout the grid 203, e.g., such that each sub-region 201 is comprised of a substantially equivalent surface area. Alternatively, the sub-regions 201 can be comprised of a plurality of sub-regions having varying sizes, which can be user-determined in a manner as described below. Nevertheless, the total surface area of all the sub-regions 201 together is preferably less than or equal to the total surface area of grid 203.

The application of grid 203 onto each webpage 100 can be automatic and/or controlled by a user. Boundary lines 205 outlining the borders of each sub-region 201 are preferably minimally obtrusive and can be applied and removed as desired by the user during e.g., application and removal of grid 203.

A control apparatus 200 (e.g. comprising a keyboard or other device having a plurality of buttons/switches/jog-dial wheels, etc.) can be provided operably connected to control the features/actions/functions of webpage 100. According to one embodiment, at least one first control element (e.g., a first control element 202) can be provided configured to at least ‘scroll’ through/activate the individual sub-regions 201 and at least one second control element (e.g., a second control element 204) can be provided configured to at least activate/select individual hyperlinks 101.

It is to be noted that any number/type of control elements can be used/configured to activate/select sub-regions 201 and/or hyperlinks 101, and can e.g., be defined/configured by user input and preferences and/or available hardware. For example, page up/down keys on a keyboard can be used to browse forward and backward through the sub-regions 201, cursor up/down keys can be used to activate a hyperlink 101, and an ‘Enter’ key can be used to make the final selection of the activated hyperlink. Especially on handheld devices, however, it can be desirable to reduce the number of control elements to a minimum. For example, the number of control elements could even be reduced to one, e.g., where a single control element is provided configured to alternate/change functions after a short timeout (period of a few seconds).

According to one embodiment, e.g., in which two control elements are used, the first control element 202 can be used to activate each sub-region 201 individually, and the second control element 204 can be provided configured to scroll through (‘activate’) each link 101 in an activated sub-region 201. According to one aspect, the ‘scrolling’ or activation process is preferably done, e.g., with each individual sub-region or hyperlink being activated in consecutive order within its respective media document/sub-region. When a desired hyperlink is activated via the second control 204, it can be selected using the first control element 202. Thus, e.g., in this embodiment, the control elements can be designated with specific functions depending on the state of browsing/selection. That is, a first control element can be used to activate a sub-region, and a second control element can be used to browse through the activated sub-region and activate (e.g., ‘highlight’) a desired hyperlink. The first control element can be used again to select the activated link.

An application of the above embodiment provides when a web page is divided into sub-regions as composed by grid 203. Once the web page is divided into sub-regions, a sub-region 210 will be highlighted. When control element 202 is activated, a sub-region 212 will be highlighted, and sub-region 210 will be un-highlighted. If the first control element 202 is pressed again, sub-region 214 will be highlighted and sub-region 212 will be un-highlighted. This type of approach can be applied to all of the other sub-regions in a counter-clockwise fashion. Alternatively, when the first control element 202 is activated (from sub-region 210), sub-region 216 will be highlighted (as to have the highlighted regions go in a clock-wise fashion).

An optional embodiment of the invention is demonstrated in FIGS. 2B and 2C. When a sub-region 210 is selected by the use of the first control element 202, the display of the device showing the web page 100 of FIG. 2A will be zoomed in exclusively to the sub-region 210, as shown in FIG. 2B. The invention will then zoom in to a second sub-region 216, as shown in FIG. 2C, if the first control element 202 is activated again. Other sub-regions (in a clockwise or counter-clockwise fashion) will be zoomed into each time the first control element 202 is activated.

The determination of the actual keys/buttons/dial wheels, etc. to be designated as the first and second control elements 202, 204 is arbitrary and the location/orientation of the buttons shown in FIG. 2A is for illustrative purposes only. The designation of the first and second control elements can be user-determined, and configured to further facilitate, e.g., one-handed operation of a keyboard during the browsing process. Currently available handheld devices like PDAs usually have several different control elements like side buttons and jog-dial wheels on the device. Functions such as, e.g., ‘sub-region activation,’ ‘hyperlink activation’ and ‘hyperlink select’ functions can be assigned to easily accessible buttons on a handheld device, thus providing greatly improved efficiency during media browsing.

During the ‘scrolling’ or activation process, each sub-region/link being considered by the user preferably provides a visual indication of its ‘active’ status by being displayed, e.g., in highlighted form, different colors, fonts, etc.

A system and method according to the present principles provides vastly improved efficiency in time and effort-required on a user's part during media navigation and browsing, e.g., by drastically reducing the number of keystrokes required as well as eliminating the need to use a point and click device (‘mouse’) during browsing. A user can thus perform a media-browsing process entirely via a keyboard (or other button-controlled device), therefore eliminating, e.g., any back-and-forth movement between a mouse and keyboard. For example, according to the embodiment shown in FIG. 2A, selecting the ‘Weather’ link advantageously requires much fewer keystrokes (e.g., only about ten keystrokes—five for activating the appropriate sub-region and five to activate/select the ‘Weather’ link).

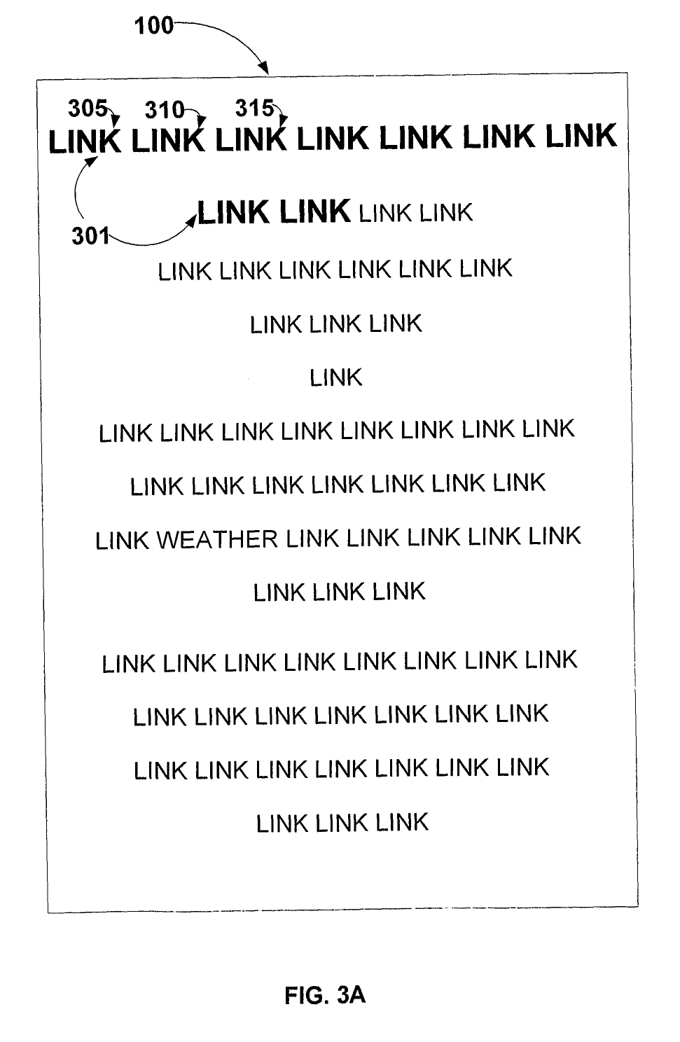

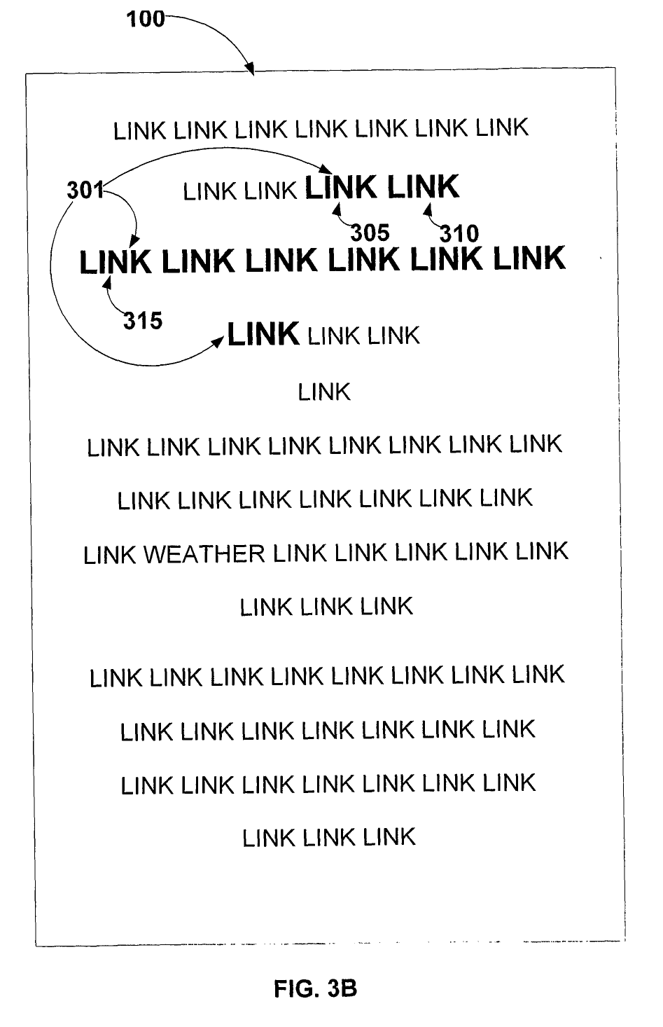

FIGS. 3A and 3B represent an exemplary media document in the form of a web page 100 including a plurality of hyperlinks, wherein groups of hyperlinks are organized according to another embodiment of the present principles. In this embodiment, sub-regions 301 are organized as separate groupings of preferably consecutive hyperlinks. The number of hyperlinks in each group 301 can be predetermined and/or varied as desired (e.g., based on user input). As each sub-region 301 is activated, a visual indication can be provided (e.g., as shown, the text of the activated sub-region 301 can be highlighted or bolded). That is, FIG. 3A shows a first group of links 301 that are highlighted when a first control element 202 is activated, and a second region of links 301 (as shown in FIG. 3B) is activated when the first control element 202 is activated again. Additional groupings of links will be highlighted when the first control element 202 upon further activations of the control element.

The highlighted links in sub-region 301 can be selected by operating the second control element 204 (operating as a second source) which advances between different links (305, 310, 315) each time it is activated. A link would then be selected as to bring up a resource corresponding to the link either by operating a third control element or by holding done the second control element 204 for a period of time. Other ways to select a link using a control element or control elements within a sub-region can be performed in accordance with the principles of the invention.

An optional feature for determining sub-regions 301 enables a user to specify how many hyperlinks are to be displayed in a sub-region 301 at a time. Hence, the amount of elements in a sub-region 301 can be expanded or reduced based on such a number. Preferably, the amount of elements in a sub-region 301 will match the number of input keys for a device, but the lack of keys for a device or specifying a number less than the number of input keys on a device is also acceptable for this optional feature. This feature can also be applied to grid 203 in FIG. 2A which can be divided into sub-regions of irregular shapes, where a sub-region 201 can be larger or smaller than a sub-region 205, depending on the amount of hyperlinks in such a region.

It is to be noted that sub-regions (e.g., 201 or 301) can be presented to the user as being visually distinguishable from each other, via, e.g., the use of different colors, fonts, etc. for hyperlinks in different sub-regions. That is, referring to FIG. 2, a sub-region 210 can be a first color and a sub-region 212 would be presented as a different color. Such colors then can be mapped to input keys on a device, so that a user can select a sub-region by using such a color, instead having to map a region to a particular symbol present on an input key.

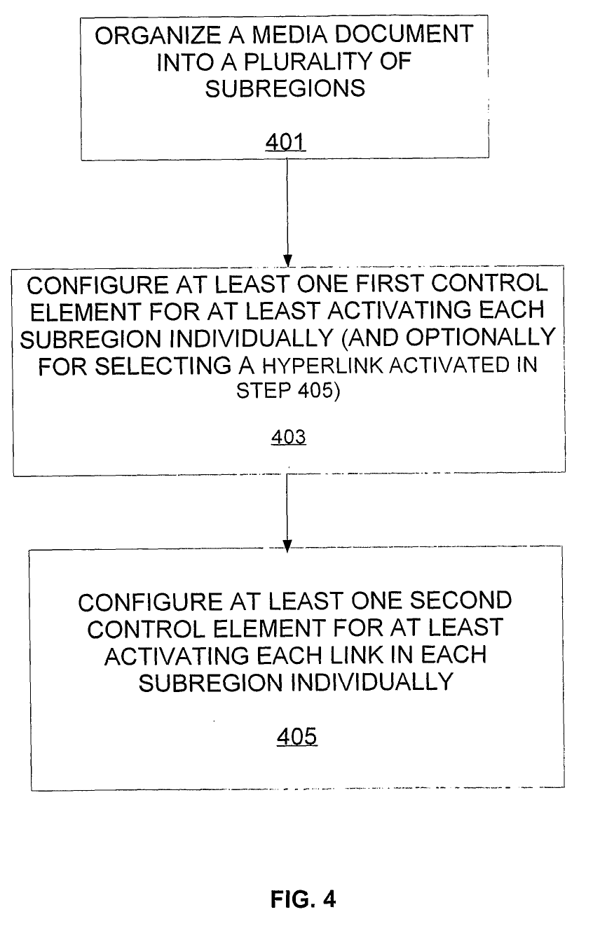

FIG. 4 is an exemplary method flow for providing a system for browsing electronic media according to one embodiment of the present principles. In step 401, a media document including hyperlinks is organized into a plurality of sub-regions, e.g., a grid comprised of individual sections can be superimposed on top of the media document. In step 403, at least one first control element or key is provided and configured for enabling a user to at least ‘scroll’ through (activate) each sub-region individually. The at least one first control element can optionally be further configured for selecting a hyperlink that has been activated by the second control element as described in step 405 below.

In step 405, at least one second control element is provided and configured for at least activating each link in an activated sub-region. Upon activation of the desired hyperlink, the at least one first control element can be used to select the activated hyperlink. Alternatively, additional control elements can be provided for activation/selection of at least one of the sub-regions/hyperlinks.

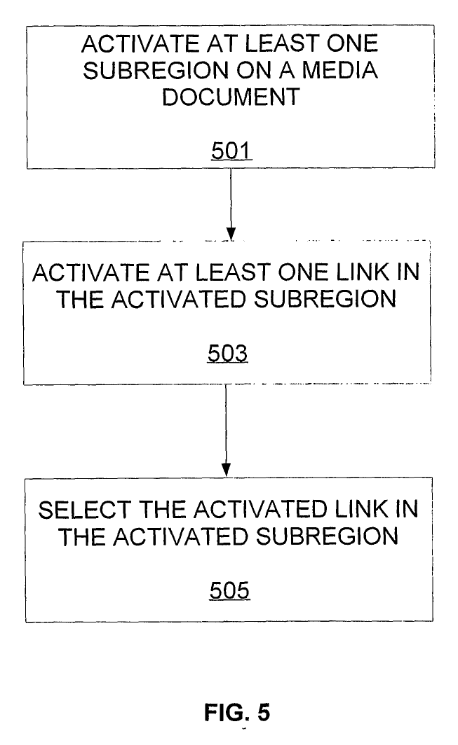

FIG. 5 is an exemplary method flow for browsing electronic media according to one embodiment of the present principles. In step 501, at least one sub-region in a media document is activated by a user using at least one first control element or key. Once a sub-region has been activated, the user can scroll through and activate at least one hyperlink within the activated sub-region using at least one second control element (step 503). The activated hyperlink can be selected, e.g., using the at least one first control element (step 505).

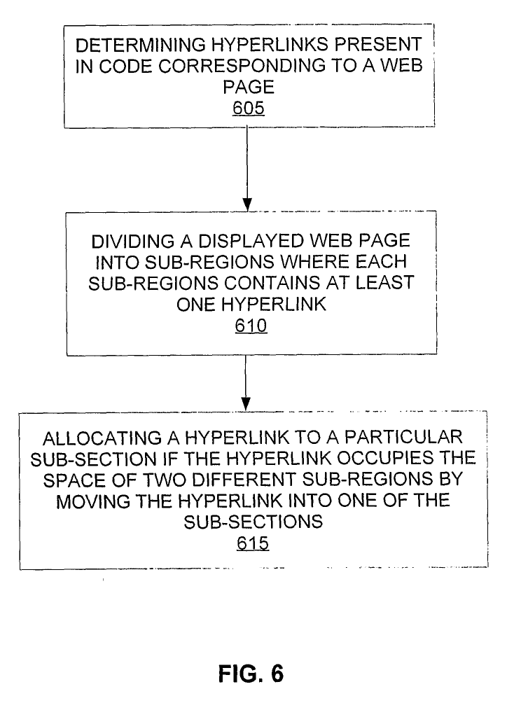

FIG. 6 is an exemplary method flow for allocating hyperlinks between different sub-regions according to one embodiment of the present principles. In step 605, the computer code (such as HTML or JAVA computer code, and the like) corresponding to a webpage is analyzed for any hyperlinks that are in the code. Preferably, this step will look for text strings that begin with the header “http”, “www” or end with the suffix “.com”, “.net”, “.gov”, or an associated country code such as “.uk” or “.fr”. Additionally, a hyperlink can be identified by searching for text strings that are in the form of a Internet Protocol v.4 or v.6 format, or begin with a “href” tag (which typically proceeds an http address). Other approaches can be used as known in the art.

In step 610, a web page is rendered with respective sub-regions (as shown in FIGS. 2A-2C or in FIGS. 3A-3B). When using a grid 203, the web page will be displayed with respective sub-regions, where the sub-regions are determined based upon the spatial criteria (i.e., the grid will break up the web page into a series of rectangles as shown in FIG. 2A). Preferably, each sub-region will contain at least one hyperlink, although this condition does not have to be met for all sub-regions.

An alternative embodiment to step 610 will construct the web page in sub-regions by highlighting a specified number of links (in a manner consistent with FIGS. 3A and 3B). The number of highlighted hyperlinks is selected in conformance with a determined number that may be incremented or decreased according to user preferences. The determination of how many hyperlinks exist in the code of a web page was previously performed in step 605.

In step 615, a determination is made to check if a displayed hyperlink overlaps at least two sub-regions. For example, as shown in FIG. 2A, a link 230 overlaps two different sub-regions 210 and 216. One way to make such a determination is to run a collision check graphic algorithm which determines if a line of grid 203 intersects a particular hyperlink. A second way of determining whether a hyperlink occupies two sub-regions is assign each hyperlink a unique identifier. A matching algorithm then is run to determine if the unique identifier is present in more than one sub-region.

If the results of either of the approaches above indicates that a hyperlink does in fact occupy two different sub-regions, a simple approach will assign the hyperlink 230 to a first sub-region (see FIG. 2B) where such a link will not occupy a second sub-region (see FIG. 2C). A second more complex approach determines how much of the area of a sub-region is occupied by the hyperlink. The sub-region whose area is occupied by more of the hyperlink will be assigned the hyperlink. Other approaches for assigning a hyperlink to a particular sub-region can be performed in accordance with the principles of the present invention.

Although the embodiment which incorporates the teachings of the present principles has been shown and described in detail herein, those skilled in the art can readily devise many other varied embodiments that still incorporate these teachings. Having described preferred embodiments for a system and method for configuring and browsing a web page (which are intended to be illustrative and not limiting), it is noted that modifications and variations can be made by persons skilled in the art in light of the above teachings. It is therefore to be understood that changes can be made in the particular embodiments of the present principles disclosed which are within the scope and spirit of the present principles as outlined by the appended claims. Having thus described the present principles with the details and particularity required by the patent laws, what is claimed and desired protected by Letters Patent is set forth in the appended claims.

1. A method for selecting hyperlinks in a media document comprising:
in a media document having a plurality of hyperlinks, grouping said plurality of hyperlinks into a plurality of sub-regions of said media document, where each sub-region comprises at least one hyperlink from said plurality of hyperlinks;
enabling selection among said sub-regions response to a first control signal from a first source; and
enabling selecting among said at least one hyperlink in a selected sub-region responsive to a second control signal from a second source.

2. The method of claim 1, wherein said second control element is further configured to select an activated hyperlink within an activated sub-region.

3. The method of claim 1, wherein the sub-regions comprise individual areas of a displayed grid superimposed on the media document.

4. The method of claim 1, wherein the sub-regions comprise visually distinguishable sub-regions.

5. The method of claim 1, wherein the sub-regions comprise groups of consecutive hyperlinks.

6. The method of claim 5, wherein a number of hyperlinks in each group is based on user input.

7. The method of claim 1 comprising the additional steps of:
determining whether said hyperlink occupies at least two sub-regions,
generating displayable information corresponding to said hyperlink in a first sub-region selected from said at least two-sub-regions and not displaying said hyperlink in said second sub-region from said at least two sub-regions, if said hyperlink does occupy said at least two sub-regions.

8. A method for browsing electronic media comprising the steps of:
organizing a media document including a plurality of hyperlinks into a plurality of sub-regions; and
providing at least one first control element configured to at least activate each individual sub-region.

9. The method of claim 8, further comprising the step of providing a second control element configured to at least activate each individual hyperlink in an activated sub-region, wherein the first control element is further configured to select an activated hyperlink within an activated sub-region.

10. The method of claim 8, wherein the sub-regions comprise individual areas of a grid superimposed on the media document.

11. The method of claim 10, wherein grid intersects a link which is contained within a first and a second sub-region of said plurality of sub-regions, said method end up will displaying said link completely said first sub-region, and not display said link in said second sub-region.

12. The method of claim 8, wherein the sub-regions comprise visually distinguishable sub-regions.

13. The method of claim 8, wherein the sub-regions comprise groups of consecutive hyperlinks.

14. The method of claim 8, wherein a number of hyperlinks in each sub-region is based on user input.

15. A method for browsing electronic media by activating at least one hyperlink among a plurality of hyperlinks in a displayed media document comprising:
grouping said plurality of hyperlinks into at least two sub-regions of said media document, where each sub-region comprises at least one hyperlink from said plurality of hyperlinks;
enabling selection of each of said sub-regions through activation of a first control element;
enabling selection of at least one hyperlink in a selected sub-region through activation of a second control element, and
enabling access of a content in the electronic media through activation of said selected hyperlink.
